(19) United States
(12) Patent Application Publication
(10) Pub. No.: US 2026/0312415 A1
(43) Pub. Date: Oct. 8, 2026

(54) SYSTEMS AND METHODS FOR INVERTER SYNCHRONIZATION

(71) Applicant: Caterpillar Inc., Peoria, IL (US)

(72) Inventors: Jesse R. GERDES, Dunlap, IL (US); Rushil THAKKER, Peoria, IL (US); Jean Marcos LOBO DA FONSECA, Peoria, IL (US); Dachuan YU, Dunlap, IL (US); Jackson WAI, Dunlap, IL (US)

(73) Assignee: Caterpillar Inc., Peoria, IL (US)

(21) Appl. No.: 19/169,638

(22) Filed: Apr. 3, 2025

(51) Int. Cl. H02J 3/46; H02M 7/5395

(52) U.S. Cl. CPC H02J 3/46; H02M 7/5395

(57) ABSTRACT

A system for inverter synchronization includes a first inverter connected to a power source and a first inverter controller. The first inverter controller is configured to receive a signal including an input frequency, generate a first carrier wave associated with the first inverter, and generate a first pulse width modulation (PWM) signal based on the input frequency and based on the first carrier wave of the first inverter. The system further includes a second inverter connected to the power source and a second inverter controller. The second inverter controller is configured to receive the first PWM signal from the first inverter controller and adjust a second carrier wave based on the first PWM signal from the first inverter controller.

### TECHNICAL FIELD

The present disclosure relates generally to electrical power equipment, and more particularly, to an energy storage system inverter system.

### BACKGROUND

Power systems are useful in various environments, including in configurations including generator sets, energy storage systems, solar power systems, and others. Power systems can be used to stabilize electrical power distribution for on-grid or off-grid settings, including systems at a worksite or mine. These systems can include power generation groups that may be used to transfer power between AC components, such as a power source, an electrical grid or microgrid, and DC components, such as a battery bank or loads on a machine, in a variety of environments in conditions, including remote conditions.

Power generation groups can contain multiple inverters connected to a transformer for power transfer between AC components and DC components. The inverters may be bidirectional, transferring power from AC components to the DC components, or vice versa. In some examples, the AC components may be power sources such as motors, turbines, or generators associated with a microgrid and the DC components may be a battery bank for storing power generated by the turbines and generators. In other examples, the inverters may be transferring power from a battery bank to AC loads.

Instantaneous differences in voltage outputs of the inverters can result in current circulation between the multiple inverters. This current circulation may cause undesired heating, which in turn reduces efficiency and limits the output power of the system. One potential cause of instantaneous differences in voltage outputs is asynchronous operation between the multiple inverters.

U.S. Pat. No. 8,648,559 issued Feb. 11, 2014 (“the '559 patent”), discloses a first motor for applying rotational energy to a respective first wheel of a vehicle and a second motor arranged for applying rotational energy to a respective second wheel of the vehicle. A first inverter is coupled to the first motor, where the first inverter is capable of receiving direct current electrical energy from a direct current bus. The first inverter is configured to provide a first group of alternating currents with a corresponding reference phase. The '559 patent further discloses a second inverter that is coupled to the second motor. The second inverter is capable of receiving direct current electrical energy from the direct current bus. The second inverter is configured to provide a second group of alternating currents with a phase shift with respect to the reference phase, such that the phase shift is effective to reduce the direct current ripple on the direct current bus. However, the '559 patent does not disclose inverter controllers that are configured to generate a synchronization signal useful for adjusting carrier waves, for example.

The systems and methods of the present disclosure may solve one or more of the problems set forth above and/or other problems in the art. The scope of the current disclosure, however, is defined by the attached claims, and not by the ability to solve any specific problem.

### SUMMARY

In one aspect, a system may include a first inverter connected to a power source and a first inverter controller. The first inverter controller may be configured to receive a signal including an input frequency, generate a first carrier wave associated with the first inverter, and generate a first pulse width modulation (PWM) signal based on the input frequency and based on the first carrier wave of the first inverter. The system may further include a second inverter connected to the power source and a second inverter controller. The second inverter controller may be configured to receive the first PWM signal from the first inverter controller and adjust a second carrier wave based on the first PWM signal from the first inverter controller.

In another aspect, a method of synchronizing carrier waves may include generating, at a first inverter controller, a first synchronization signal based on a first carrier wave, receiving, at a second inverter controller, the first synchronization signal, and modifying, at the second inverter controller, a second carrier wave for a second inverter based on the first synchronization signal to synchronize a phase of the second carrier wave with a phase of the first carrier wave by determining a phase difference between a first reference point on the first synchronization signal and a second reference point on the second carrier wave. Upon determining that the phase difference between the first reference point and the second reference point is less than zero, the method may include pausing, at the second controller, the second carrier wave. Upon determining that the phase difference between the first reference point and the second reference point is greater than zero, the method may include jumping, at the second controller, a phase angle of the second carrier wave forward.

In yet another aspect, a system may include a plurality of inverters, each of the inverters comprising a respective inverter controller. Each of the respective inverter controllers may be configured to receive an incoming PWM signal, adjust a carrier wave based on the PWM signal, generate an output PWM signal based on the adjusted carrier wave, and transmit the output PWM signal to another inverter controller.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a block diagram of a system configured to transfer power between components, according to aspects of the disclosure.

FIG. 2 provides a flow diagram for generating a synchronization signal for the system of FIG. 1.

FIG. 3A provides a flow diagram for synchronization of carrier waves.

FIG. 3B provides a further flow diagram for synchronization of carrier waves.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

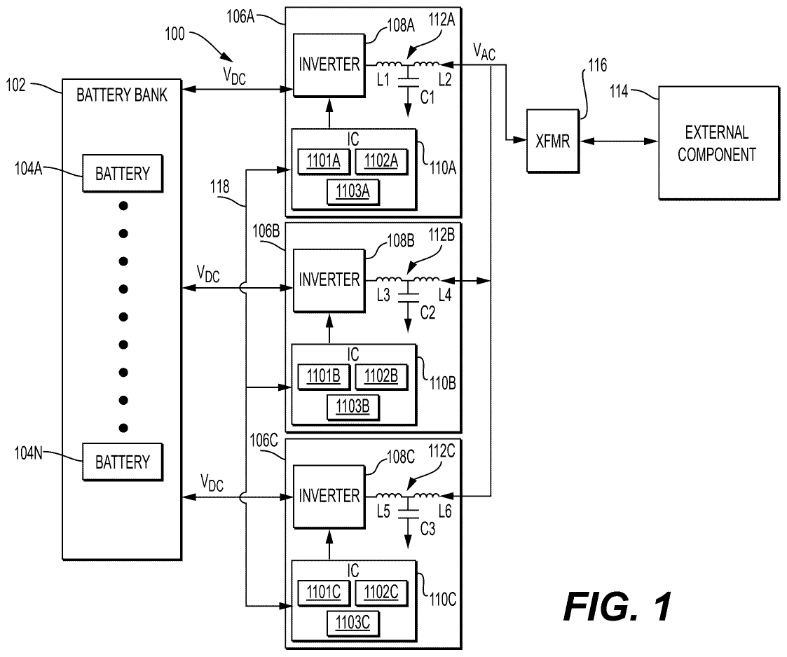

FIG. 1 is a block diagram of an inverter synchronization system 100 that can manage power transfer between components, such as in a grid connected inverter, a microgrid inverter, a charger, or similar applications, according to aspects of the disclosure. The system 100 includes a battery bank 102 having a plurality of energy storage devices such as batteries 104A-104N, which may be coupled in series, or in parallel, with one another. The battery bank 102 may provide or receive a DC voltage V_{DC} to one or more inverter systems, of which a first inverter system 106A, a second inverter system 106B, and a third inverter system 106C are shown in FIG. 1. While DC voltage V_{DC} is shown as a series of separate connections between battery bank 102 and inverter systems 106A-106C, as understood, a shared DC bus may connect battery bank 102 to a plurality of inverter systems (e.g., systems 106A, 106B, and 106C). There may be more or fewer inverter systems than the three inverter systems 106 shown in FIG. 1. Each of the inverter systems 106 may be a bidirectional power unit, such that power can be transferred to or from the battery bank 102 from inverter systems 106.

Each inverter system 106, such as inverter system 106A, includes an inverter, such as inverter 108A. The inverter 108A may receive the DC voltage V_{DC} and, using a plurality of switches controlled by an inverter controller (“IC”) 110A, generate and outputs an AC voltage V_{AC} via a filter circuit 112A. The filter circuit 112A of the inverter 108A includes a capacitor C1 that is coupled to an electrical grid. The filter circuit of inverter system 106A also includes inductors L1, L2 and the capacitor C1.

Each inverter system, such as inverter system 106A, may output an AC voltage V_{AC} that can be supplied to an external component 114 via a transformer 116. In some embodiments, the external component 114 includes a grid (e.g., an electrical grid or a microgrid). In some embodiments, the external component 114 may include a motor or a generator. Supplying a DC voltage to the inverter 108A discharges the batteries 104A-104N in the battery bank 102.

In some examples, such as when the external component 114 is a grid, inverter system 106A may receive the AC voltage V_{AC}. The inverter 108A may rectify the AC voltage V_{AC} and generate a DC voltage V_{DC} that can charge the batteries 104A-104N in the battery bank 102. Inverter systems 106B and 106C may operate comparably.

In some examples, the inverter controllers may be connected in a star arrangement (now shown), which includes a single leader and a plurality of followers. In these examples, a leader, such as the first inverter controller 110A may generate a first synchronization signal based on the first carrier wave of the first inverter 108A and transmit the first synchronization signal to the followers, such as the second inverter controller 110B and the third inverter controller 110C to synchronize the second carrier wave of the second inverter 108B and the third carrier wave of the third inverter 108C with the first carrier wave. In some examples, there may be N inverters systems where N is a positive integer, and there may be one leader and N−1 followers.

In some examples, the inverter controllers may be arranged in a serial arrangement, as shown in FIG. 1, where a leader generates a synchronization signal that is sent to a first follower, which then generates another synchronization signal that is sent to a second follower, etc. In these examples, a leader, such as the first inverter controller 110A may generate a first synchronization signal based on the first carrier wave of the first inverter 108A and transmit the first synchronization signal to the second inverter controller 110B to synchronize the second carrier wave of the second inverter 108B with the first carrier wave. The second inverter controller 110B may generate a second synchronization signal based on the second carrier wave and transmit the second synchronization signal to the third inverter controller 110C to synchronize the third carrier wave of the third inverter 108C with the second carrier wave. In these examples, each follower is a leader to the next inverter in a serial arrangement. There may be N inverter systems in these examples, where N is a positive integer, and each of the N inverter controllers may be a leader and a follower, with the exceptions of the first inverter, which only acts as a leader, and the Nth inverter, which only acts as a follower. While three inverter systems are described in the example inverter synchronization system 100, there may be as few as two inverter systems.

The inverter controllers may be connected in a ring arrangement, also represented in FIG. 1, where a leader generates a synchronization signal that is sent to a first follower, which then generates another synchronization signal that is sent to a second follower, etc. The last follower in the arrangement then generates a synchronization signal that is sent to the leader, completing the ring. The process may be iterative such that, when the leader receives the synchronization signal from the last follower, it may generate a new synchronization signal, and the process repeats. Alternatively, other inverter controllers than the leader may receive the synchronization signal from the last follower. In these examples, a leader, such as the first inverter controller 110A may generate a first synchronization signal based on the first carrier wave and transmit the first synchronization signal to the second inverter controller 110B to synchronize the second carrier wave with the first carrier wave. Subsequently, the second inverter controller 110B may generate a second synchronization signal based on the second carrier wave and transmit the second synchronization signal to the third inverter controller 110C to synchronize the third carrier wave with the second carrier wave. The third inverter controller 110C may then generate a third synchronization signal based on the third carrier wave of the third inverter 108C and transmit the third synchronization signal to the first inverter controller 110A to synchronize the first carrier wave with the third carrier wave. The first inverter controller 110A may then generate a fourth synchronization signal based on the first carrier wave that has been modified based on the third synchronization signal, and transmit the fourth synchronization signal to the second inverter controller 110B to synchronize the modified second carrier wave with the modified first carrier wave. There may be N inverter systems in these examples, where N is a positive integer, and each of the N inverter controllers may be a leader and a follower. While three inverter systems are described in the example, there may be as few as two inverter systems.

The inverter controllers 110A, 110B, 110C may include one or more processors, controllers, or field programmable gate arrays (FPGA), or a combination thereof. Each of the inverter controllers, such as first inverter controller 110A, second inverter controller 110B, and third inverter controller 110C, may also include, for example, a data communication interface, and a central processing unit in the form of one or more processors, for executing program instructions. The inverter controllers may each include an internal communication bus, and a storage unit (such as ROM, HDD, SDD, etc.) that may store data on a computer readable medium, although the inverter controllers may receive programming and data via network communications. The inverter controllers may also have a memory (such as RAM) storing instructions for executing techniques presented herein, although the instructions may be stored temporarily or permanently within other modules of the inverter controllers (e.g., the one or more processors or the computer readable medium).

Each inverter controller, such as first inverter controller 110A, second inverter controller 110B, and third inverter controller 110C, may include a carrier wave generator 1101A-C configured to generate a carrier wave at a given frequency. To avoid a phase difference, one or more of the inverter controllers 110A-110C may generate a synchronization signal, as described above.

### INDUSTRIAL APPLICABILITY

Inverter synchronization system 100 may be applied in power systems capable of transferring power between an AC end and a DC end via a plurality of inverters. One or more components of system 100 may, during operation, generate a synchronization signal based on a carrier wave of the first inverter to be transmitted to subsequent inverters. The downstream inverters may be controlled by respective inverter controllers that receive the synchronization signal from the first inverter controller and modify the respective carrier waves of the subsequent inverters if they are out of phase with the first inverter.

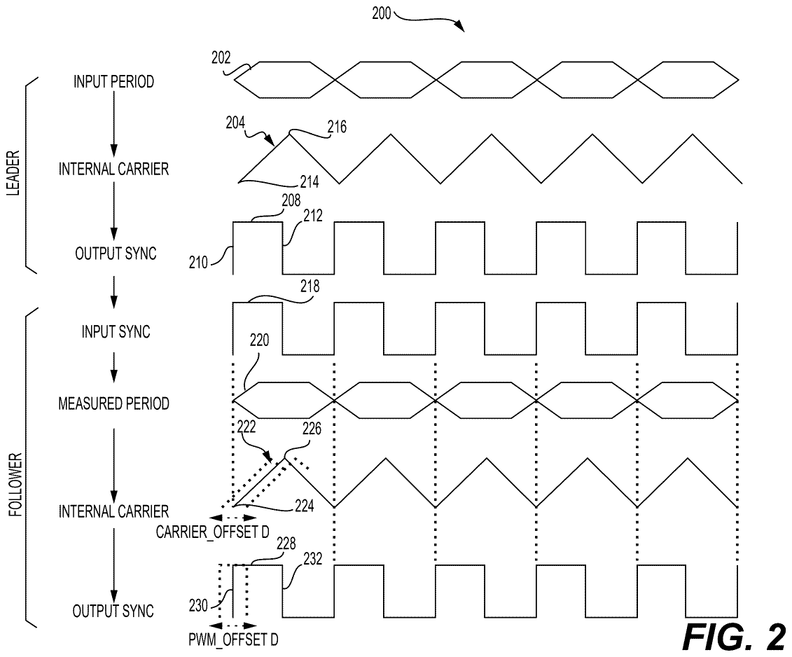

FIG. 2 provides a diagram 200 for generating a synchronization signal, according to aspects of the disclosure. A leader inverter controller, such as the first inverter controller 110A, may receive an input frequency or an input period 202, the input frequency and input period being inverses of each other. The input period may be input by a user of system 100 and/or programmed into and stored in a memory of one or more of the inverter controllers, such as first inverter controller 110A. The period for the follower may be the measured period of the synchronization input period. Based on the input period 202, a first carrier wave 204 of the first inverter 108A is generated at a first carrier wave generator 1101A. The first carrier wave may have, for example, a triangular waveform or sinusoidal waveform.

Based on the first carrier wave 204, a first synchronization signal 208 may be generated by first PWM generator 1103A. The first synchronization signal 208 may be, for example, a pulse width modulation (PWM) signal that represents the first carrier wave 204. For example, the first synchronization signal 208 may be a PWM signal that includes a leading edge 210 and a trailing edge 212, where the leading edge 210 corresponds to a first feature of the first carrier wave, such as a trough 214 of triangular wave form 206, and the trailing edge 212 corresponds to a second feature of the first carrier wave, such as a peak 216. The leader inverter controller does not receive an input synchronization signal, instead receiving an input frequency or input period 202.

Follower controllers, such as second inverter controller 110B, may receive an input synchronization signal 218, such as an input PWM, based on the output synchronization signal 208 Based on the input synchronization signal 218, a period 220 or frequency of the follower is measured at a follower carrier wave generator, such as second carrier wave generator 1101B. Based on the input synchronization signal 218 representing the carrier wave 204 of a leader, an offset D is determined (e.g., measured or calculated) between the follower carrier wave 222 and the leader by second carrier wave generator 1101B. The second carrier wave generator 1101B then modifies or adjusts the second carrier wave 222 to synchronize with the carrier wave 204 of the leader, such that the frequency of the leader and the frequency of the follower are equal and in phase, e.g., have substantially the same wave form with substantially simultaneous troughs and peaks, eliminating the phase difference or offset D. For example, trough 214 and trough 224 may be aligned, and peak 216 and peak 226 may be aligned.

In some examples, the input frequency (e.g., input period 202) may be equal to the frequency of the carrier wave, or may be a fraction of the frequency of the carrier wave, e.g., ½, ⅓, or ¼ of the frequency of the carrier wave.

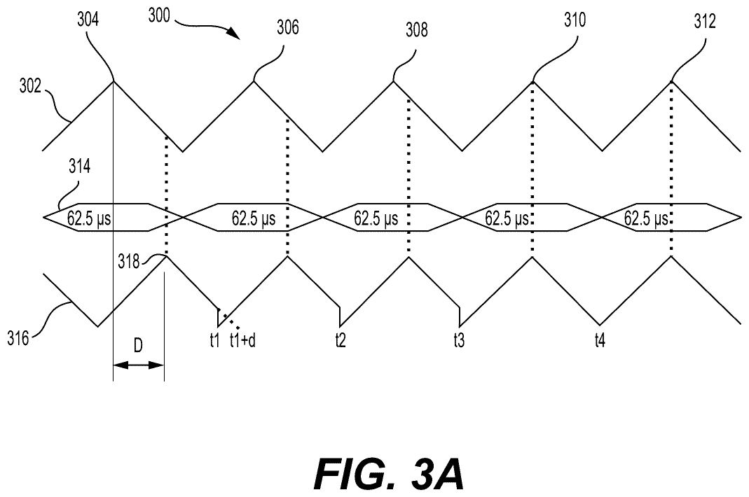

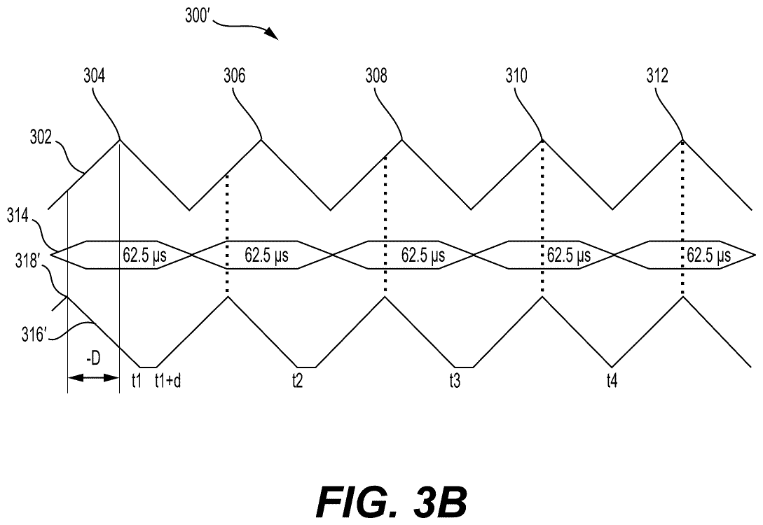

FIGS. 3A and 3B provide diagrams for synchronization of carrier waves, according to aspects of the disclosure. As shown in FIG. 2, a synchronization signal based on the carrier wave of a leader, e.g., the carrier wave of the first inverter 108A, is transmitted to the controller of one or more followers, e.g., the second inverter controller 110B. The second inverter controller may calculate an equivalent angle of the received synchronization signal 218 and offset the calculated angle waveform to account for delays from the first inverter controller 110A. The second inverter controller 110B may use a synchronization signal based on the calculated angle waveform to compare to the internal second carrier wave 222 of the second inverter 108B. At certain synchronization points, the second inverter controller may either (i) modify the second carrier wave by jumping a phase angle of the second carrier wave forward or (ii) modify the second carrier wave by pausing the second carrier wave for a predetermined phase angle, thereby allowing the receiver to synchronize the second carrier wave of the second inverter with the first carrier wave of the first inverter.

The diagram in FIG. 3A shows the function of system 100 to modify a follower carrier wave by jumping a phase angle forward. The diagram in FIG. 3B shows the function of system 100 to modify a follower carrier wave by pausing the phase angle for a predetermined time. The diagrams in FIGS. 3A and 3B may apply to synchronizing any follower inverter with a leader inverter.

FIG. 3A provides a diagram 300 for modifying a second carrier wave 222 by jumping, or advancing, a phase angle of the second carrier wave forward when a phase difference between the synchronization signal. The leader internal carrier wave 302 may be a triangular waveform, where the synchronization signal 208 transmitted by a leader inverter controller, as described in FIG. 2, indicates features of the triangular waveform, such as a first peak 304, second peak 306, third peak 308, fourth peak 310, and fifth peak 312. The peaks may correspond to successive trailing edges of the PWM signal of synchronization signal 208 described in FIG. 2, successive leading edges of the PWM signal described in FIG. 2, or a combination of leading edges and trailing edges. In the example shown in FIG. 3A, the peaks 304, 306, 308, 310, 312 correspond to successive trailing edges 212 or 232 (FIG. 2).

The follower inverter controller measures a period 314 of the follower carrier wave 316 of the follower inverter, which may likewise be a triangular waveform. The follower inverter controller then determines a phase difference between corresponding features of the leader carrier wave and the follower carrier wave. In the example shown in FIG. 3A and FIG. 3B, the features are successive peaks, such as the first peak 304 of the leader carrier wave 302 and the first peak 318 of the follower carrier wave 316. The follower inverter controller determines a phase difference between the two features.

In the example shown in FIG. 3A, a phase difference D is shown, where D is by convention determined to be greater than zero, indicating that the first peak 304 of the leader carrier wave 302 is ahead of the first peak 318 of the follower carrier wave 316, or in other words, the first peak 304 of the leader carrier wave 302 occurs before the first peak 318 of the follower carrier wave 316.

Upon determining that the phase difference D is greater than zero, the follower inverter controller may be programmed to “jump” the follower carrier wave 316 ahead in order to adjust to reduce and ultimately eliminate the phase difference D. Jumping the follower carrier wave 316 ahead may be accomplished by altering the value of the signal of the carrier wave to a value that it would reach at a later time if the wave remained unaltered. For example, as shown in FIG. 3A, at time t1, the amplitude value of the follower carrier wave 316 may be set to a value that the follower carrier wave 316 would have reached at time t1+d, jumping the follower carrier wave 316 ahead by a time d. In the example shown in FIG. 3A, d=D/3, such that after three jumps at times t1, t2, and t3, the follower carrier wave 316 has become synchronized with the leader carrier wave 302. The follower inverter controller may be programmed to limit the size of the jump to minimize the effect of the synchronization on the follower inverter's carrier wave.

FIG. 3B provides a simplified flow diagram for modifying the second carrier wave by pausing the second carrier wave for a predetermined phase angle upon determining the phase difference between the third feature and the first leading edge and/or the phase difference between the fourth feature and the first trailing edge is less than zero. In the example shown in FIG. 3B, a phase difference −D is shown, where −D is by convention determined to be less than zero, indicating that the first peak 304 of the leader carrier wave 302 is behind the first peak 318′ of the follower carrier wave 316′, or in other words, the first peak 304 of the leader carrier wave 302 occurs after the first peak 318′ of the follower carrier wave 316′.

Upon determining that the phase difference D is less than zero (e.g., −D), the follower inverter controller may be programmed to pause the follower carrier wave 316 ahead in order to adjust to reduce and ultimately eliminate the phase difference −D. Pausing the follower carrier wave 316′ may be accomplished by holding the value of the signal of the carrier wave for a time d. For example, as shown in FIG. 3B, at time t1, the value of the follower carrier wave 316′ may be paused such that the follower carrier wave 316′ has the same value at time t1+d as it did at time t. When the pause is completed, the follower carrier wave 316′ continues its trajectory. In the example shown in FIG. 3B, d=D/3, such that after three pauses at times t1, t2, and t3, the follower carrier wave 316′ has become synchronized with the leader carrier wave 302. The follower inverter controller may be programmed to limit the time of the pause to minimize the effect of the synchronization on the follower inverter's carrier wave.

Additionally, the inverter controllers may be programmed to ignore jumps or pauses that are expected to be below a certain magnitude, thereby allowing a slight deviation between primary and secondary controllers, to minimize possible effects of synchronization on a cycle by cycle basis.

FIGS. 2-3B illustrate an input frequency that is substantially equal to the frequency of the carrier waves of the inverters. However, synchronization could be achieved at a reduced rate, with synchronization signals generated at frequencies lower than the input frequency. To minimize high frequency electromagnetic interference and to make the signals more robust to noise, the rate of synchronization may be reduced. For example, the synchronization signal may be based on an input frequency that is equal to a frequency of the first carrier wave divided by N, where N is a whole number. In these examples, the first feature of the first carrier wave used for synchronization may be a first trough of the first carrier wave, and the second feature of the first carrier wave used for synchronization may be a second trough of the first carrier wave, wherein the second trough occurs N cycles after the first trough.

The follower inverter controller may be configured to clock the cycles required to receive a synchronization signal, and either jump or pause at the appropriate cycle, where the appropriate cycle is N cycles after a prior synchronization signal had been received. For example, if the carrier wave has a frequency of 16 kHz and the synchronization signal has a frequency of 8 kHz, N is determined to be two (16 kHz/8 kHz). As such, the receiver would be configured to receive a synchronization signal 2 cycles after a previous synchronization signal.

As discussed above, depending on whether the inverter controllers are arranged in a star arrangement, a serial arrangement, a ring arrangement, or some other arrangement, each of the inverter controllers may be a leader, a follower, or both a leader and a follower. Furthermore, there may be multiple leaders and multiple followers, or a single leader and multiple followers, etc.

The system and method may provide techniques to limit current circulation when transferring power between an AC end and a DC end via a plurality of inverters by synchronizing the carrier waves of the multiple inverters. The system and method may be applied to power generation groups that contain multiple inverters connected to a transformer for power transfer between AC components, such as an electrical grid or microgrid, and DC components, such as a battery bank or loads on a machine. For example, to limit current circulation, an inverter controller of a first inverter may generate a synchronization signal based on a carrier wave of the first inverter to be transmitted to subsequent inverters. The subsequent inverters may be controlled by respective inverter controllers that receive the synchronization signal from the first inverter controller and modify the respective carrier waves of the subsequent inverters if they are out of phase with the first inverter. Reducing instantaneous differences in voltage outputs of the inverters results in improved efficiency and power output of the system by reducing current circulation between the multiple inverters.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

1. A system comprising:
a first inverter connected to a power source;
a first inverter controller, the first inverter controller configured to:
receive a signal including an input frequency,
generate a first carrier wave associated with the first inverter, and
generate a first pulse width modulation (PWM) signal based on the input frequency and based on the first carrier wave of the first inverter; and
a second inverter connected to the power source;
a second inverter controller, the second inverter controller configured to:
receive the first PWM signal from the first inverter controller, and
adjust a second carrier wave based on the first PWM signal from the first inverter controller.

2. The system of claim 1, wherein:
the second inverter controller is further configured to generate a second PWM signal based on the adjusted second carrier wave, the system further comprising:
a third inverter; and
a third inverter controller, the third inverter controller configured to:
receive the second PWM signal from the second inverter controller, and
adjust a third carrier wave of the third inverter based on the second PWM signal from the second inverter controller.

3. The system of claim 1, wherein:
the second inverter controller is configured to generate a second PWM signal based on the adjusted second carrier wave, and
the first inverter controller is configured to receive the second PWM signal from the second inverter controller, and to adjust the first carrier wave of the first inverter based on the second PWM signal from the second PWM inverter.

4. The system of claim 1, wherein:
the first PWM signal comprises a first leading edge corresponding to a first feature of the first carrier wave and a first trailing edge corresponding to a second feature of the first carrier wave; and
the second inverter controller is configured to:
determine a phase difference between a third feature of the second carrier wave and the first leading edge and/or a phase difference between a fourth feature of the second carrier wave and the first trailing edge; and
modify the second carrier wave in one or more increments until the phase difference between the third feature and the first leading edge is substantially zero.

5. The system of claim 4, wherein the second inverter controller is configured to:
modify the second carrier wave by jumping a phase angle of the second carrier wave forward upon determining the phase difference between the third feature and the first leading edge and/or the phase difference between the fourth feature and the first trailing edge is greater than zero.

6. The system of claim 4, wherein the second inverter controller is configured to:
modify the second carrier wave by pausing the second carrier wave for a predetermined phase angle upon determining the phase difference between the third feature and the first leading edge and/or the phase difference between the fourth feature and the first trailing edge is less than zero.

7. The system of claim 4, wherein:
the input frequency is equal to a frequency of the first carrier wave;
the first feature of the first carrier wave is a trough of the first carrier wave; and
the second feature of the first carrier wave is a peak of the first carrier wave.

8. The system of claim 4, wherein:
the input frequency is equal to a frequency of the first carrier wave divided by N, where N is a whole number;
the first feature of the first carrier wave is a first trough of the first carrier wave; and
the second feature of the first carrier wave is a second trough of the first carrier wave, wherein the second trough occurs N cycles after the first trough.

9. A method of synchronizing carrier waves, the method comprising:
generating, at a first inverter controller, a first synchronization signal based on a first carrier wave;
receiving, at a second inverter controller, the first synchronization signal; and
modifying, at the second inverter controller, a second carrier wave for a second inverter based on the first synchronization signal to synchronize a phase of the second carrier wave with a phase of the first carrier wave by:
determining a phase difference between a first reference point on the first synchronization signal and a second reference point on the second carrier wave;
upon determining that the phase difference between the first reference point and the second reference point is less than zero, pausing, at the second controller, the second carrier wave; and
upon determining that the phase difference between the first reference point and the second reference point is greater than zero, jumping, at the second controller, a phase angle of the second carrier wave forward.

10. The method of claim 9, further comprising:
generating, at the second controller, a second synchronization signal based on the second carrier wave;
receiving, at a third controller, the second synchronization signal; and
modifying, at the third controller, a third carrier wave based on the second synchronization signal to synchronize a phase of the third carrier wave with the phase of the first carrier wave and the phase of the second carrier wave.

11. The method of claim 9, further comprising:
generating, at the second controller, a second synchronization signal based on the second carrier wave;
receiving, at the first controller, the second synchronization signal; and
adjusting, at the first controller, the first carrier wave based on the second synchronization signal.

12. The method of claim 9, wherein:
jumping the phase angle of the second carrier wave forward is performed in one or more increments until the phase difference between the first reference point and the second reference point is substantially zero.

13. The method of claim 9, wherein:
pausing the second carrier wave for a predetermined phase angle is performed in one or more increments until the phase difference between the first reference point and the second reference point is substantially zero.

14. The method of claim 9, wherein the first synchronization signal is a first PWM signal.

15. The method of claim 14, wherein:
the first PWM signal comprises a first leading edge corresponding to a first feature of the first carrier wave and a first trailing edge corresponding to a second feature of the first carrier wave; and
adjusting the second carrier wave comprises:
determining a phase difference between a third feature of the second carrier wave and the first leading edge and/or a phase difference between a fourth feature of the second carrier wave and the first trailing edge; and
modifying the second carrier wave in one or more increments until the phase difference between the third feature and the first leading edge is substantially zero.

16. The method of claim 15, wherein:
the first feature of the first carrier wave is a trough of the first carrier wave; and
the second feature of the first carrier wave is a peak of the first carrier wave.

17. The method of claim 15, wherein:
the first feature of the first carrier wave is a first trough of the first carrier wave; and
the second feature of the first carrier wave is a second trough of the first carrier wave.

18. A system comprising:
a plurality of inverters, each of the inverters comprising a respective inverter controller, wherein each of the respective inverter controllers is configured to:
receive an incoming PWM signal;
adjust a carrier wave based on the PWM signal;
generate an output PWM signal based on the adjusted carrier wave; and
transmit the output PWM signal to another inverter controller.

19. The system of claim 18, wherein the output PWM signal comprises a first leading edge corresponding to a first feature of the adjusted carrier wave and a first trailing edge corresponding to a second feature of the adjusted carrier wave.

20. The system of claim 18, wherein the plurality of inverters are arranged in a ring arrangement, such that each of the inverter controllers is configured to receive an incoming PWM signal from one or more other inverter controllers.
